(19) United States
(12) Patent Application Publication
(10) Pub. No.: US 2025/0156173 A1
(43) Pub. Date: May 15, 2025

(54) SELECTIVE PERFORMANCE OF APPLICATION UPDATES BASED ON APPLICATION ACTIVATION REGIONS

(71) Applicant: International Business Machines Corporation, Armonk, NY (US)

(72) Inventors: Kushal S. Patel, Pune (IN); Gandhi Sivakumar, Mountain View, CA (US); Sarvesh S. Patel, Pune (IN)

(21) Appl. No.: 18/510,239

(22) Filed: Nov. 15, 2023

(51) Int. Cl. G06F 8/65

(52) U.S. Cl. CPC G06F 8/65

(57) ABSTRACT

A computer-implemented method, according to one embodiment, includes generating a map of a first satellite's orbital path with respect to Earth's surface, and identifying, on the map along the first satellite's orbital path, a first activation region of Earth's surface. A first application is expected to be activated on the first satellite for a duration that a footprint coverage region of the first satellite is within the first activation region. In response to a determination that the footprint coverage region of the first satellite is within the first activation region, first application updates are prevented from being performed on the first satellite. In response to a determination that the footprint coverage region of the first satellite is not within the first activation region, performance of the first application updates is caused on the first satellite.

### BACKGROUND

The present invention relates to satellites, and more specifically, this invention relates to selective performance of application updates based on a satellite's footprint coverage region's position with respect to activation regions.

Communication networks typically include a plurality of communication devices that communicate with other communication devices via wireless signals. For example, communication devices may include, e.g., computers, cellular phones, fax machines, network enabled tablets, etc. These wireless signals are sometimes relayed via communication relay devices on the Earth's surface, e.g., ground antennas, routers, modems, etc. In some cases, these wireless signals may additionally and/or alternatively be transmitted via connection requests that are output from communication devices to satellites.

Cloud providers, e.g., such as corporations, establish relationships with satellite companies in some cases in order to achieve two distinctly different objectives. For example, commercial satellite constellations generate relatively extensive amounts of data that needs to be stored, processed, and analyzed. This makes these satellite companies prime customers for the cloud providers. Meanwhile, the expansion of edge computing beyond traditional terrestrial network connections drives direct connections between data centers and satellite broadband ground stations to reduce latency and increase application speeds. Applications are used by satellites in order to enable these storing, processing, and analyzing operations.

### SUMMARY

A computer-implemented method, according to one embodiment, includes generating a map of a first satellite's orbital path with respect to Earth's surface, and identifying, on the map along the first satellite's orbital path, a first activation region of Earth's surface. A first application is expected to be activated on the first satellite for a duration that a footprint coverage region of the first satellite is within the first activation region. In response to a determination that the footprint coverage region of the first satellite is within the first activation region, first application updates are prevented from being performed on the first satellite. In response to a determination that the footprint coverage region of the first satellite is not within the first activation region, performance of the first application updates is caused on the first satellite.

A computer program product, according to another embodiment, includes a computer readable storage medium having program instructions embodied therewith. The program instructions are readable and/or executable by a computer to cause the computer to perform any combination of features of the foregoing methodology.

A system, according to another embodiment, includes a processor, and logic integrated with the processor, executable by the processor, or integrated with and executable by the processor. The logic is configured to perform any combination of features of the foregoing methodology.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2 is a flowchart of a method, in accordance with one embodiment of the present invention.

FIG. 3 is an infrastructure, in accordance with one embodiment of the present invention.

FIG. 4 is a table, in accordance with one embodiment of the present invention.

FIG. 5 is an environment, in accordance with one embodiment of the present invention.

FIG. 6 is a dictionary, in accordance with one embodiment of the present invention.

FIG. 7 is a schedule, in accordance with one embodiment of the present invention.

FIG. 8 is a flowchart of a method, in accordance with one embodiment of the present invention.

FIGS. 9A-9C depict an environment, in accordance with several embodiments of the present invention.

FIG. 10 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for selective performance of application updates based on a satellite's footprint coverage region's position with respect to activation regions.

In one general embodiment, a computer-implemented method includes generating a map of a first satellite's orbital path with respect to Earth's surface, and identifying, on the map along the first satellite's orbital path, a first activation region of Earth's surface. A first application is expected to be activated on the first satellite for a duration that a footprint coverage region of the first satellite is within the first activation region. In response to a determination that the footprint coverage region of the first satellite is within the first activation region, first application updates are prevented from being performed on the first satellite. In response to a determination that the footprint coverage region of the first satellite is not within the first activation region, performance of the first application updates is caused on the first satellite.

In another general embodiment, a computer program product includes a computer readable storage medium having program instructions embodied therewith. The program instructions are readable and/or executable by a computer to cause the computer to perform any combination of features of the foregoing methodology.

In another general embodiment, a system includes a processor, and logic integrated with the processor, executable by the processor, or integrated with and executable by the processor. The logic is configured to perform any combination of features of the foregoing methodology.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as application update determination code of block 150 for selective performance of application updates based on a satellite's footprint coverage region's position with respect to activation regions. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

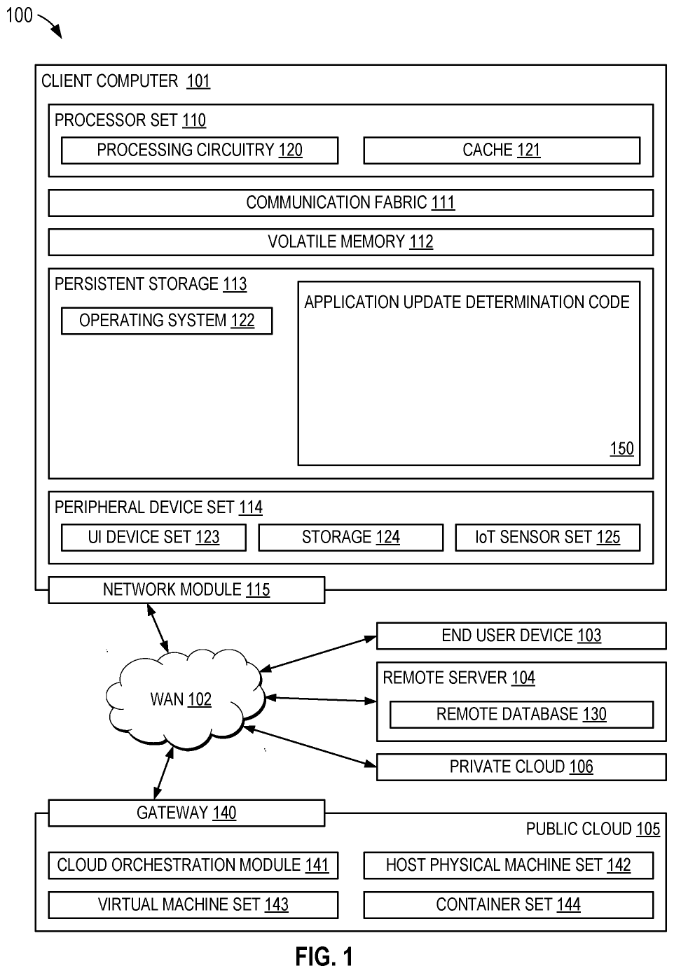

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, communication networks typically include a plurality of communication devices that communicate with other communication devices via wireless signals. For example, communication devices may include, e.g., computers, cellular phones, fax machines, network enabled tablets, etc. These wireless signals are sometimes relayed via communication relay devices on the Earth's surface, e.g., ground antennas, routers, modems, etc. In some cases, these wireless signals may additionally and/or alternatively be transmitted via connection requests that are output from communication devices to satellites.

Cloud providers, e.g., such as corporations, establish relationships with satellite companies in some cases in order to achieve two distinctly different objectives. For example, commercial satellite constellations generate relatively extensive amounts of data that needs to be stored, processed, and analyzed. This makes these satellite companies prime customers for the cloud providers. Meanwhile, the expansion of edge computing beyond traditional terrestrial network connections drives direct connections between data centers and satellite broadband ground stations to reduce latency and increase application speeds. Applications are used by satellites in order to enable these storing, processing, and analyzing operations.

Low earth orbit (LEO) satellite datacenters and mechanisms to send and receive information from LEO satellites directly via a communication network offers a performance benefit to applications and devices accessing data from LEO satellites directly. For example, because devices may be directly connected to LEO processing locations, a transmission latency is relatively very low due to the omitted interference of intermediate network components. Furthermore, because LEO satellites orbit relatively close to Earth's surface, they can be used for communication purposes where the device (mobile or IoT devices) on Earth can connect directly to the LEO satellites for performing a data exchange (instead of earth based eNodeBs). This enables relatively faster data transmission between a network and devices because they are directly connected to a LEO satellite. Conventional 5G capable mobile devices and future 6G capable devices may be configured to possess capabilities to use techniques described herein to connect to the LEO transceivers where LEO satellites thereafter act as eNodeBs and serve connections to target endpoints.

LEO satellites typically revolve around the Earth's surface at relatively lower altitudes than geo-stationary satellites, and therefore are not stationary with respect to Earth's movement. Because this movement of LEO satellites can be observed from Earth, and LEO satellites are relatively much closer to Earth surface than other satellites, to maintain a rotation equilibrium, the speed of LEO satellites is relatively greater, which impacts the footprint region when these LEO satellites are used for direct connection purposes. This also means that the footprint coverage region, e.g., the region of Earth's surface that a given satellite can accept and process connection requests from at a given time, is fairly limited for LEO satellites, as well as associated coverage timelines. For this reason, there may be multiple LEO satellites orbiting a plane of Earth which act as a mesh to offer continuous coverage for an area. The LEO satellites in the mesh are configured to communicate with one another via an inter-satellite link which offers a relatively high speed network line between the LEO satellites.

When referring to satellite-based data centers, all data is expected to be processed and saved by LEO satellites, and specifically, the data is typically saved within the LEO satellite's persistent storage devices. In such cases, it becomes relatively extremely efficient to process and keep the data at an edge location which has LEO satellite coverage, e.g., from an edge computing perspective and in terms of end to end bandwidth requirements. In terms of datacenter management activities, there are often a plurality of operations which have a need for actions in terms of updating. For example, these updates include, e.g., maintenance of devices, software component upkeep operations such as garbage collection, upgrades, etc. These updates are typically performed on a continuous basis within a datacenter device. In the case of earth-based datacenters, this ongoing update process is considered acceptable because the updates are mostly static in nature and there are no motion dynamics involved in the application workload sensitivity. However, in the case of LEO based datacenters, there is conventionally no techniques applied for identifying an acceptable time for performing maintenance activities, e.g., such as software upgrades, concurrent code upgrade, internal software processing like garbage collection, cache cleaning, etc. The different sets of orbits followed by different LEO satellites further complicates this problem. Accordingly, update operations are conventionally scheduled to be performed on a LEO satellite without considering the workload and location of the LEO satellite. Accordingly, conventional LEO satellites sometimes initiate application updates and other tasks during and/or before relatively intensive workloads are performed, which significantly compromises the throughput of these LEO satellites.

In sharp contrast to the deficiencies of the conventional techniques described above, the techniques of embodiments and approaches described herein work with LEO satellite-based data centers to collect information, e.g., infrastructure management service information with respect to motion dynamics, activation timelines for LEO datacenter components, trajectory information, etc., and use the collected information to create time windows in which a LEO satellite can perform internal maintenance work. These generated timeline windows are preferably validated against the orbital characteristics of one or more associated LEO satellites, with defined frequency and alterations made to ensure a correctness of the timelines. The maintenance activities, e.g., application updates and/or other events, are assessed for their timelines and scheduled with the available window time to ensure a consistent application performance for end users accessing data.

In some approaches, these approaches include causing a process running the LEO satellite datacenter manager service to be initiated and collect the information about hardware and software components that are used for the maintenance activities. These components may include storage appliances, application instances, and internal system components such as device RAM, cache, NAND flash solid state drives in the datacenters, etc. An interface collects the information and locates the components based on determined priorities and interrupt masking capacities. There are some events such as SSD garbage collection that cannot be masked for relatively longer periods of time, and therefore an understanding of the priority of the events for scheduling activity improves efficiencies of the LEO environment. The service further collects the information from various LEO infrastructure resources about motion dynamics of the LEO satellite. This includes orbital characteristics, <Hmin, Hmax> tuple details and motion information including the direction vectors, speed and rotation information which the saved into the metadata mapper classes for further information extraction. From collected motion dynamics, the coverage footprint is determined to understand locations points that a footprint coverage region of a LEO satellite will pass over. This information is used to determine timeline windows for inactivity based on the applications.

Information from an application platform interface is gathered for the activation timelines to understand which applications are used in different geographical areas. For example, a LEO satellite may be hosting an application that only has permissions to run in a specific country's territory. Then depending on the motion dynamics calculated, these techniques may be used to map a timelines of footprint coverage region for such respective territories. For infrastructure components, activation times for all the respective applications may be identified and inactivity timelines may be gathered. The collective information about inactivity timelines may then be used as the maintenance activity window for the combined. This may be different for individual components, depending on which applications are accessed on which infrastructure. Accordingly, individual windows may be located for the application software or infrastructure. All the windows timelines are calculated and updated into a dictionary with information that details types of applications, and the timelines which can be used for a given activity selection.

In response to a determination that a service maintenance request is received, timelines requirements for an activity, e.g., a storage enclosure upgrade may take three hours while an application upgrade may take only fifteen minutes, may be determined and mapped with priorities of actions. An action-oriented map may be generated to schedule an activity in an inactivity timeline for the respective components involved. Once the respective timeline window is available, the respective service execution is triggered so that the service may be computed and completed within a timeline in which there is no relatively heavy impact on an application as well as on underlying infrastructure. This mitigates customer dissatisfaction that would otherwise occur if such updates were performed while the LEO satellite was passing over a servicing window. This way, in some use cases, application updates and other tasks that consume processing resources are performed while the footprint coverage region of a LEO satellite is passing over the ocean or another body of water rather than overpopulated portions of land. Additionally, because the maintenance and grooming activities are performed before a relatively heavy workload is undertaken by a LEO satellite, the possibility of an application crash is minimized. This translates to a performance gain for end users of the applications.

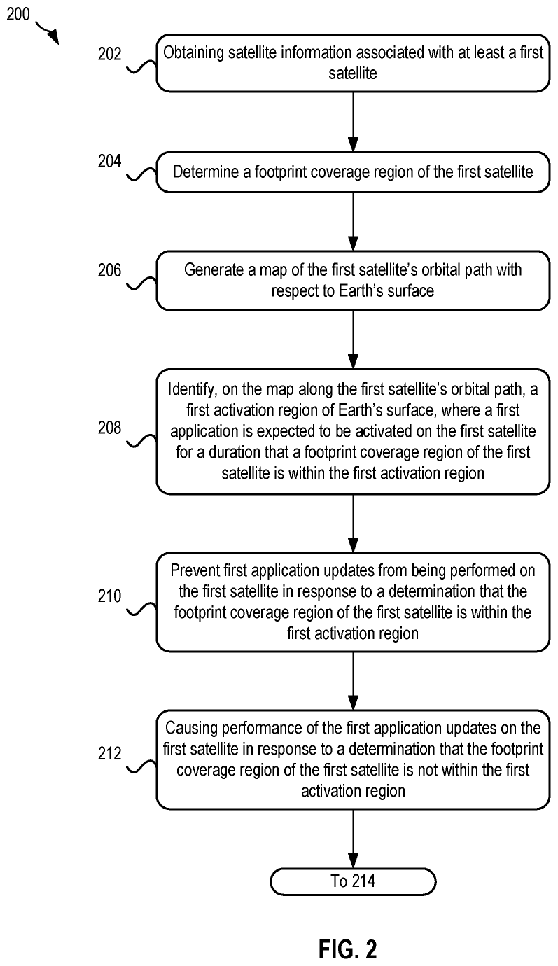

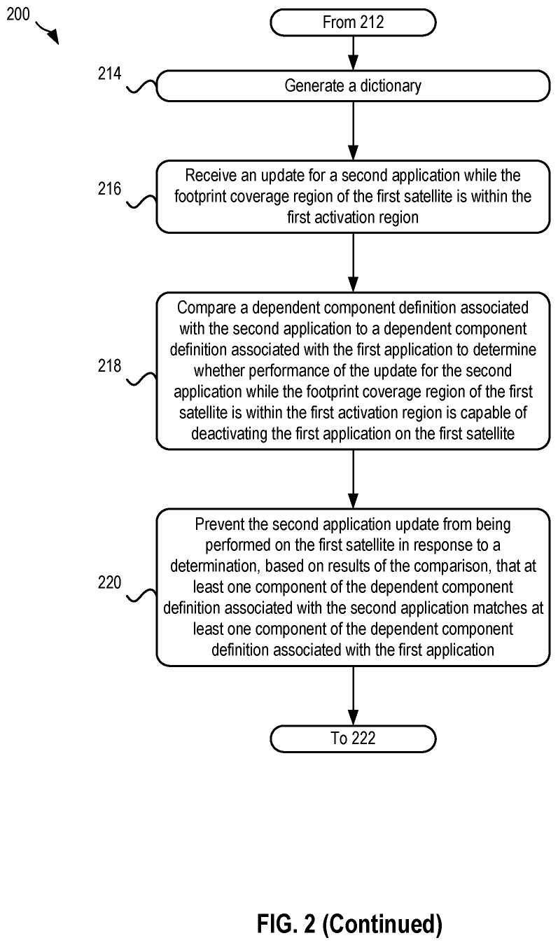

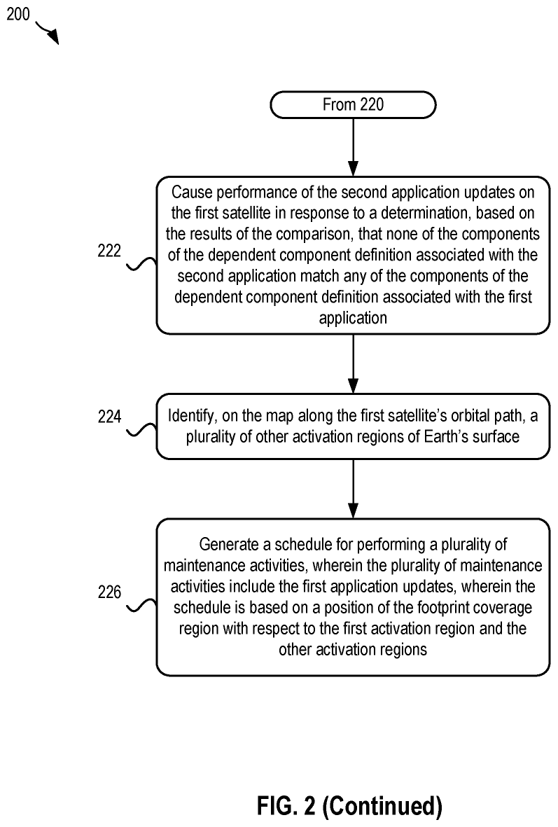

Now referring to FIG. 2, a flowchart of a method 200 is shown according to one embodiment. The method 200 may be performed in accordance with the present invention in any of the environments depicted in FIGS. 1-10, among others, in various embodiments. Of course, more or fewer operations than those specifically described in FIG. 2 may be included in method 200, as would be understood by one of skill in the art upon reading the present descriptions.

Each of the steps of the method 200 may be performed by any suitable component of the operating environment. For example, in various embodiments, the method 200 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 200. Illustrative processors include, but are not limited to, a central processing unit (CPU), an application specific integrated circuit (ASIC), a field programmable gate array (FPGA), etc., combinations thereof, or any other suitable computing device known in the art.

Operation 202 includes obtaining satellite information associated with at least a first satellite. In some preferred approaches, at least the first satellite is a LEO satellite.

The satellite information may be obtained by a processing circuit that is located in the satellite(s) and/or by a processing circuit that is in communication with at least one of the satellites. In such an approach, the processing circuit of the first satellite may be configured to offload jobs from the first satellite (e.g., for another satellite to perform) and/or accept jobs from other satellites. Furthermore, in such an approach, the processing circuit may additionally and/or alternatively be configured to use the satellite information pertaining to other satellites to determine one or more metrics associated with the other satellites. In some other approaches, the satellite information may be obtained by a computer that is in communication with one or more of the satellites. The satellite information may, in some approaches, include, e.g., identifiers (IDs) of satellites, predetermined metrics associated with the satellites, software versions being run on the different satellites, etc. In some approaches the predetermined metrics associated with the satellites include, e.g., a current altitude of a satellite, a trajectory of a satellite, orbital plane information of a satellite, an average moving speed of a satellite, an orbital path of a satellite, a shape of a satellite's orbital path, etc. The processing circuit of the first satellite may additionally and/or alternatively be configured to initiate performance of management activities on the first satellite, e.g., application updates, housekeeping operations, garbage collection operations, etc.

The satellite information associated with the plurality of other satellites may be obtained from and/or as data structures of the satellites. Upon instantiation, the data structures may be loaded to a service instance, and predefined data collection resources may be triggered to send data streams from an associated satellite to other satellites orbiting the Earth. For context, data streams may be sent between satellites, a satellite and a target device, e.g., such as transmitted between a satellite and a target device on Earth's surface and/or where another satellite is the target device, e.g., a LEO satellite target device, as part of a job of a workload.

In some approaches, in order to obtain the satellite information and/or in order to establish communication paths between different satellites and/or between satellites and target devices on Earth's surface, resource capitals may be provisioned for a service using insertions to a softwarization management plane and virtual network functions may be triggered to start the data transmission over an established transmission line. Infrastructure application programming interface (API) instances of the satellites may, in some approaches, be initiated, and handshaking may be performed that is further used to transmit a data requirement signal and recognition of an event by an orchestration plane of an infrastructure that supports the satellites.

Satellite infrastructure APIs are, in some approaches, additionally and/or alternatively invoked to obtain the satellite information. For example, in some approaches in which the satellite information includes physical parameters, e.g., a current altitude, a footprint region, a trajectory, orbital plane information, an average moving speed of eNodeBs of a satellite, etc., operation 202 may include invoking satellite infrastructure APIs.

Subsequent to obtaining the satellite information, the obtained information may be used to determine movement of at least the first satellite with respect to Earth. For example, the obtained satellite information may be used to determine a trajectory of the first satellite. In some approaches, the trajectory of the first satellite may be determined, e.g., based on tracked historical orbital information associated with the first satellite, based on a current tracking of the first satellite, from a table of predetermined metrics in the obtained information, etc.

Operation 204 includes determining a footprint coverage region of the first satellite. For context, the footprint coverage region of a satellite is an area of Earth below the orbiting satellite that the satellite is within range of connecting to one or more target devices located on the area of Earth. The area of Earth below the orbiting satellite that makes up the footprint coverage region of the satellite may depend on communication hardware of the satellite. For example, in some approaches, a first LEO satellite may have a relatively larger footprint coverage region than a footprint coverage region of a second LEO satellite as a result of the second LEO satellite having relatively more outdated communication hardware, e.g., signal broadcasting hardware of a processing circuit. The footprint coverage region of a satellite may be determined based on metrics associated with the satellite, e.g., metrics from the obtained satellite information. For example, a footprint coverage region of a first satellite may be determined based on metrics associated with the first satellite, e.g., a current altitude, a trajectory, orbital plane information and an average moving speed. Techniques for determining a connectivity and/or communication range of a satellite, based on metrics associated with the satellite, which would become apparent to one of ordinary skill in the art after reading the descriptions herein may be used. The footprint coverage region of a given satellite may be used to determine candidate jobs for the satellite to fulfill, e.g., in response to a determination that the footprint coverage region of the satellite is within range of a target device for an offload data transfer, as will be described in greater detail below. As described in greater detail elsewhere herein, the footprint coverage region of a given satellite may additionally and/or alternatively be used to determine whether to perform one or more maintenance activities, e.g., such as application updates.

A map of at least the first satellite's orbital path with respect to Earth's surface is generated, e.g., see operation 206. In some preferred approaches, the map is a temporal mapping of positions of the first satellite with respect to Earth's surface, and is generated using the obtained satellite information. For at least some approaches in which the map is a temporal mapping of the first satellite, the map may be generated by appending the footprint coverage region of the first satellite with Earth's surface on a predetermined map, e.g., to indicate the footprint coverage region of the first satellite as the first satellite traverses with respect to Earth's surface. In some approaches, this appending may be performed by injecting a ground surface coordinate map with satellite geographical location information and an altitude of the satellite. The map may, in some preferred approaches, be updated after regular pre-defined intervals in order to maintain accuracy within the map.

Operation 208 includes identifying, on the map along the first satellite's orbital path, a first activation region of Earth's surface. In some preferred approaches, the first activation region of Earth's surface is a region of Earth's surface that a first application used by the first satellite is expected to be and/or recorded as previously being activated on the first satellite for a duration that a footprint coverage region of the first satellite is within the first activation region. For example, in some use cases, the first application may be a data relay application of the first satellite that is used by the first application to exchange data at least one device located in the first activation region of Earth's surface for the duration that the footprint coverage region of the first satellite is within the first activation region. In some other approaches, the first activation region may be a location that application processing is expected to occur, e.g., the location of a target device that is configured for receiving an offload data transfer from the first satellite and that is positioned along an orbital path of the first satellite.

In some use cases, the satellite information may be collected from various LEO infrastructure resources, and the satellite information may detail motion dynamics of the first satellite. For example, the information may include orbital characteristics, <Hmin, Hmax> tuple details, motion information (including the direction vectors, speed and rotation information), etc. This obtained satellite information may be saved into metadata mapper classes for further information extraction. In some of such approaches, the collected motion dynamics of the obtained satellite information may be used to determine the footprint coverage region. The footprint coverage region is determined to understand the locations points that are under a specific footprint region at a given point in time. Furthermore, information from an application platform interface may be gathered for the activation timelines in order to understand which applications are used in which geo area. Then, depending on the motion dynamics calculated, method 200 includes mapping the timelines of the footprint coverage region to different activation regions.

At least the first activation region of Earth's surface is preferably identified in order to coordinate management operations, e.g., such as performing application updates, based on the first satellites footprint coverage region with respect to the first activation region. For example, in some preferred approaches, in response to a determination that the footprint coverage region of the first satellite is within the first activation region and/or approaching the first activation region, first application updates are prevented from being performed on the first satellite, e.g., see operation 210. Preventing the first application updates from being performed on the first satellite may include, e.g., cancelling performance of the first application updates, denying performance of the first application updates, etc. According to another approach, preventing the first application updates from being performed on the first satellite may include delaying the first application updates from being performed on the first satellite until a determination is made that the footprint coverage region of the first satellite is not within the first activation region.

As a result of preventing the first application updates from being performed on the first satellite during the duration that the footprint coverage region of the first satellite is within the first activation region, processing resources that would otherwise be expended for performing the first application updates are preserved for performing other tasks that are to be performed during the duration that the footprint coverage region of the first satellite is within the first activation region. In some approaches, these “other tasks” that are to be performed during the duration that the footprint coverage region of the first satellite is within the first activation region include operations that can only be performed by the first satellite when the first satellite is within range of the first activation region. For example, these other tasks may include fulfillment of connection requests from devices positioned on Earth's surface within the first activation region.

In contrast, in some approaches, in response to a determination that the footprint coverage region of the first satellite is not within the first activation region and/or is not approaching and is not within a predetermined distance from the first activation region, performance of the first application updates is caused on the first satellite, e.g., see operation 212. In some approaches, causing performance of the first application updates on the first satellite may include at least initiating performance of the first application updates during the duration that the footprint coverage region of the first satellite is within the first activation region.

Performance of management operations, such as the first application updates described above, may, in some approaches, be based on determined priorities of the management operations. In order to determine such priorities, in some approaches, information about hardware and software components that are used on the first satellite may be collected. In some approaches, the information is collected from and/or received from a program running a satellite datacenter manager service. In some approaches, the information details a list of devices and/or components and/or software sub-components that need maintenance activities performed thereon. These devices and/or components and/or software sub-components may, in some approaches, include storage appliances, internal system components (such as device RAM, cache, NAND flash solid state drives in the datacenters, etc.), application instances, etc. An interface may, in some approaches, collect the information and locate associated components. The collected information may be added to a table. For example, in some approaches, method 200 includes generating a table of events queued to be performed by the first satellite, and determining a priority of the events of the table based on at least one predetermined metric. According to some approaches, these events may include, e.g., application updates, garbage collection, storage enclosure upgrades, switch reboots, etc. In some approaches, the predetermined metric that the priority of events may be based on may include timeliness of the event, which may be defined as a timeline of when the event can be performed, e.g., as set by connectivity capabilities, as set by customer demands, as set by an available window of processing resources, etc. In another approach, the priority of events may additionally and/or alternatively be based on a predetermined metric that includes time requirements, which may be defined as how long an event is anticipated to take to be performed. In yet another approach, the priority of events may additionally and/or alternatively be based on a masking ability which may be defined as a maximum amount of time that the event can be delayed. For context, some events, e.g., SSD garbage collection, cannot be masked for relatively longer time.

In some approaches, the generated table or maintenance activities and associated priorities may be referenced to determine whether to cause a maintenance activity, e.g., such as the first application updates, to be performed despite a determination being made that a footprint coverage region of a satellite is within an activation region. For example, in some approaches, in response to the determination that the footprint coverage region of the first satellite is within the first activation region, the determined priorities may be used, e.g., considered to determine whether a priority is greater than a predetermined threshold, to determine whether to cause performance of a first of the events during a duration that a footprint coverage region of the first satellite is within the first activation region.

Although various approaches described above detail selectively causing or preventing performance of maintenance activities, e.g., the first application updates, in some approaches, some maintenance activities may be performed during the duration that the footprint coverage region of the first satellite is within the first activation region, while some other maintenance activities are prevented. For context, in some preferred approaches, maintenance activities may be performed during a duration that the footprint coverage region of the first satellite is within a given activation region provided that the performance does not prevent applications of the first satellite from being capable, e.g., functional, of fulfilling requests from the first activation region. In order to ensure that the performance of maintenance activities does not prevent applications of the first satellite from being capable of fulfilling requests from the first activation region, in some approaches, a dictionary may be generated, e.g., see operation 214. The dictionary, in some preferred approaches, includes entries for a plurality of applications including the first application. Furthermore, the dictionary includes dependent component definitions each associated with a different one of the dictionary entries, and each dependent component definition lists components that are actively used and/or functionally depended on during use of an associated one of the application uses. The obtained satellite information and/or other results of querying one or more of the satellites may be used to generate the dictionary.

Use of the generated dictionary to ensure performance of maintenance activities, e.g., application updates, does not prevent applications of the first satellite from being capable, e.g., functional, of fulfilling requests from the first activation region are described below. Operation 216 includes receiving an update for a second application. The update for the second application is received while the footprint coverage region of the first satellite is within the first activation region and/or headed towards and within a predetermined distance from the first activation region. In response to receiving the update for the second application, the dependent component definition associated with the second application is compared to the dependent component definition associated with the first application to determine whether performance of the update for the second application while the footprint coverage region of the first satellite is within the first activation region is capable of deactivating the first application on the first satellite, e.g., see operation 218. Comparison techniques that would become apparent to one of ordinary skill in the art after reading the descriptions herein may be used for comparing the definitions. In response to a determination, based on results of the comparison, that at least one component of the dependent component definition associated with the second application matches at least one component of the dependent component definition associated with the first application, the second application update is prevented from being performed on the first satellite, e.g., see operation 220. By preventing the second application update from being performed on the first satellite, request throughout within the first activation region is improved because otherwise allowing performance of the second application updates on the first satellite would compromise the first application from being used while the footprint coverage region of the first satellite is within the first activation region. In contrast, in response to a determination, based on the results of the comparison, that none of the components of the dependent component definition associated with the second application match any of the components of the dependent component definition associated with the first application, the second application updates are caused to be performed on the first satellite, e.g., see operation 222. Causing performance of the second application updates on the first satellite may, in some approaches, include at least initiating performance of the second application update during the duration that the footprint coverage region of the first satellite is within the first activation region.

It should be noted that, although various approaches above are described to be performed by the first satellite with respect to the first activation region, in some approaches, method 200 may additionally and/or alternatively be performed with respect to a plurality of activation regions, e.g., a second activation region, a third activation region, a fourth activation region, etc. For example, operation 224 includes identifying, on the map along the first satellite's orbital path, a plurality of other activation regions of Earth's surface. The plurality of different applications are expected to be and/or recorded as previously being activated on the first satellite for a duration that the footprint coverage region of the first satellite is within the other activation regions. A schedule for performing a plurality of maintenance activities is generated, e.g., see operation 226. In some approaches, the plurality of maintenance activities include the first application updates, and the schedule is based on a position of the footprint coverage region with respect to the first activation region and the other activation regions. Furthermore, in some of such approaches, the calendar may additionally and/or alternatively be based on the priorities such that relatively high priority maintenance activities are performed relatively sooner upon exit of an activation region than other maintenance activities having relatively lower priorities.

In some approaches, an illustrative process for generating the schedule includes first collecting satellite information. In some approaches, this collection may include collecting data associated with predetermined infrastructure components, e.g., the satellites, hubs on Earth's surface, devices from which requests are received on at least the first satellite, etc. Activation times for all the respective applications are identified and inactivity timelines are gathered using the collected satellite information. Collective information about inactivity timelines is identified within the information, and is used as a maintenance window for a combined schedule. In some approaches, this information may be different for individual components, e.g., depending on which applications are accessed on the infrastructure, and therefore individual windows may be located for the application software or infrastructure of one or more of the satellites. All the window timelines may be calculated and incorporated into the dictionary according to application type, and the timelines which can be used for the activity selection may be added to definitions therein. These timelines may additionally and/or alternatively be added to a schedule that is based on a comparison of the definitions of the dictionary and that lists when maintenance activities are anticipated to be performed. Thereafter, in response to receiving a service maintenance request, method 200 may include searching the schedule for determining a timeline in which the request will be fulfilled, e.g., based on a current location of footprint coverage region of the satellite that receives the service maintenance request. In some approaches, characteristics of the request are mapped with the priorities of the actions in order to determine whether or not to fulfill the request regardless of the current location of footprint coverage region of the satellite that receives the service maintenance request. The map may be updated to include information about the schedule, in some approaches, e.g., to include an inactivity timeline for respective components involved. Once a respective timeline window is available, a respective service execution may be triggered for fulfilling service requests such that computations and/or updates are performed within a timeline that results in no relatively heavy impact being incurred by the application and no relatively heavy impact being incurred by underlying infrastructure.

Various performance benefits are enabled in a communication environment that includes at least the first satellite, as a result of performing the techniques described herein. For example, in sharp contrast to conventional techniques which allow maintenance activities such as application updates to be performed without considering a current location of a satellite, the techniques described herein dynamically sense a next coverage footprint timing based on landmasses, and plan internal actions for consistent application performance. This provides a relatively better utilization of free resources based on availably using dynamic inactivity identification. Furthermore, these techniques maintain relatively clean and latest components during active client connections and avoid downtime during relatively peak periods. This equates to a proactive utilization of resources by considering the physical characteristics of orbital revolution around Earth. Furthermore, these techniques improve performance by leveraging existing resources in inactivity time windows for internal software grooming activity and enabling timely cleaning activity. As a result, timelines-based job completion expectation from resource loaners is achieved.

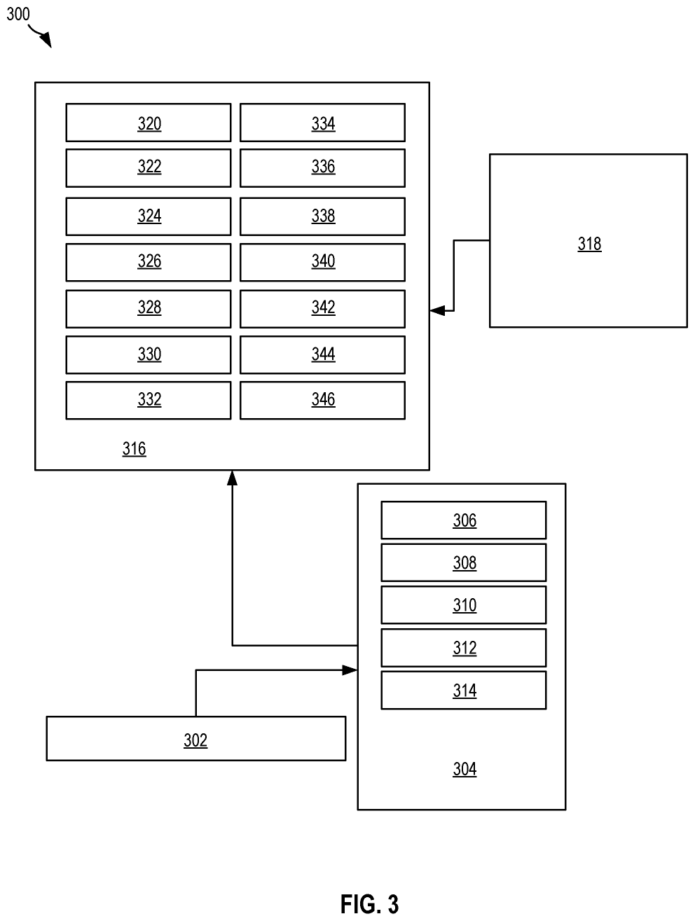

FIG. 3 depicts an infrastructure 300, in accordance with one embodiment. As an option, the present infrastructure 300 may be implemented in conjunction with features from any other embodiment listed herein, such as those described with reference to the other FIGS. Of course, however, such infrastructure 300 and others presented herein may be used in various applications and/or in permutations which may or may not be specifically described in the illustrative embodiments listed herein. Further, the infrastructure 300 presented herein may be used in any desired environment.

The infrastructure 300 includes a physical layer LEO satellite interface 302, and information from the physical layer LEO satellite interface 302 may be collected into or by a platform information gathering and insights manager 304. The platform information gathering and insights manager 304 may include a plurality of components for gathering predetermined types of satellite information, e.g., motion detector APIs 306, an orbit to availability generation component 308, a height to direction mapper component 310, a polling thread 312 configured for gathering orbital characteristics, and a direction vector identification component 314.

The infrastructure 300 may additionally and/or alternatively include an event gathering and scheduling component 316, which may be configured to receive web resources, e.g., for software upgrade checks and predetermined important notification push-pulls, of a resource module 318. The event gathering and scheduling component 316 may include a plurality of sub-components for event gathering and scheduling operations, e.g., see gathering motion map 320, validation of movement for application activity component 322, dependency tracker 324, masking to timeline management component 326, gathering of maintenance event component 328, iterative management of inactivity window component 330, discretionary manager for event trigger component 332, generate inactivity window component 334, locate components for grooming component 336, enquire masking ability component 338, event validity component 340, event parser component 342, scheduler 344, and orbit to window variation teacher component 346.

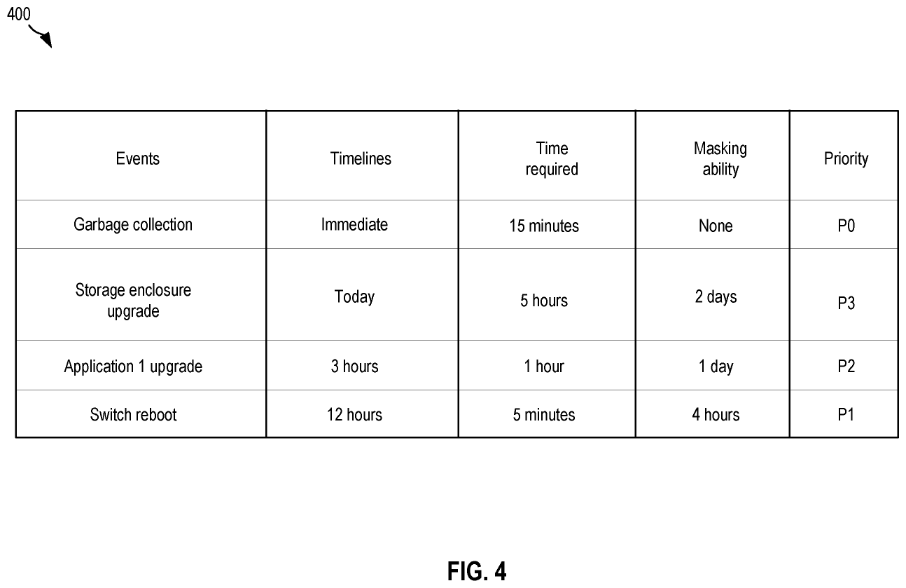

FIG. 4 depicts a table 400, in accordance with one embodiment. As an option, the present table 400 may be implemented in conjunction with features from any other embodiment listed herein, such as those described with reference to the other FIGS. Of course, however, such table 400 and others presented herein may be used in various applications and/or in permutations which may or may not be specifically described in the illustrative embodiments listed herein. Further, the table 400 presented herein may be used in any desired environment.

Table 400 includes maintenance events that are queued to be performed by a first satellite, e.g., see Garbage collection, Storage enclosure upgrade, Application 1 upgrade, and Switch reboot. A priority of the events, e.g., see Priority, of the table may be determined based on at least one predetermined metric. For example, in one approach, the predetermined metric includes timeliness which is a timeline of when the event can be performed. In another approach, the predetermined metric includes time requirements which may be defined as how long an event is anticipated to take to be performed. In yet another approach, the predetermined metric includes masking ability which may be defined as a maximum amount of time that the event can be delayed.

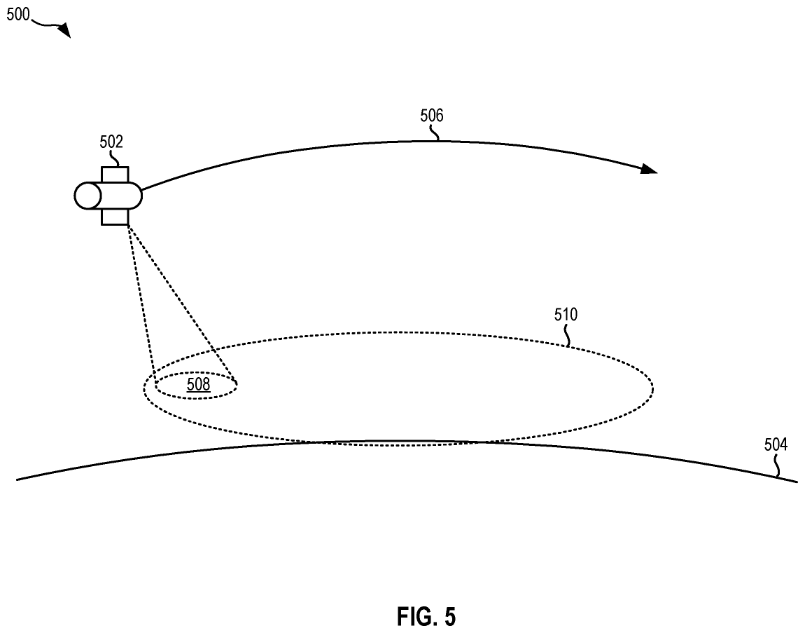

FIG. 5 depicts an environment 500, in accordance with one embodiment. As an option, the present environment 500 may be implemented in conjunction with features from any other embodiment listed herein, such as those described with reference to the other FIGS. Of course, however, such environment 500 and others presented herein may be used in various applications and/or in permutations which may or may not be specifically described in the illustrative embodiments listed herein. Further, the environment 500 presented herein may be used in any desired environment.

The environment includes a first LEO satellite 502 that is orbiting Earth's surface 504 in a first orbital trajectory 506. Information about the first LEO satellite may be obtained, e.g., a velocity, an altitude, timeline identification information (such as different servicing windows with respect to different activation regions), etc. The obtained information may be used to generate a map of the first LEO satellite's orbital path with respect to Earth's surface. A first activation region 510 of Earth's surface may be identified on the map along the first satellite's orbital path, and a first application may be expected to be and/or recorded as previously being activated on the first satellite for a duration that a footprint coverage region 508 of the first satellite is within the first activation region. In response to a determination that the footprint coverage region of the first satellite is within the first activation region and/or approaching the first activation region, first application updates are prevented from being performed on the first satellite. In contrast, in response to a determination that the footprint coverage region of the first satellite is not within the first activation region and/or approaching the first activation region, performance of the first application updates is caused on the first satellite.

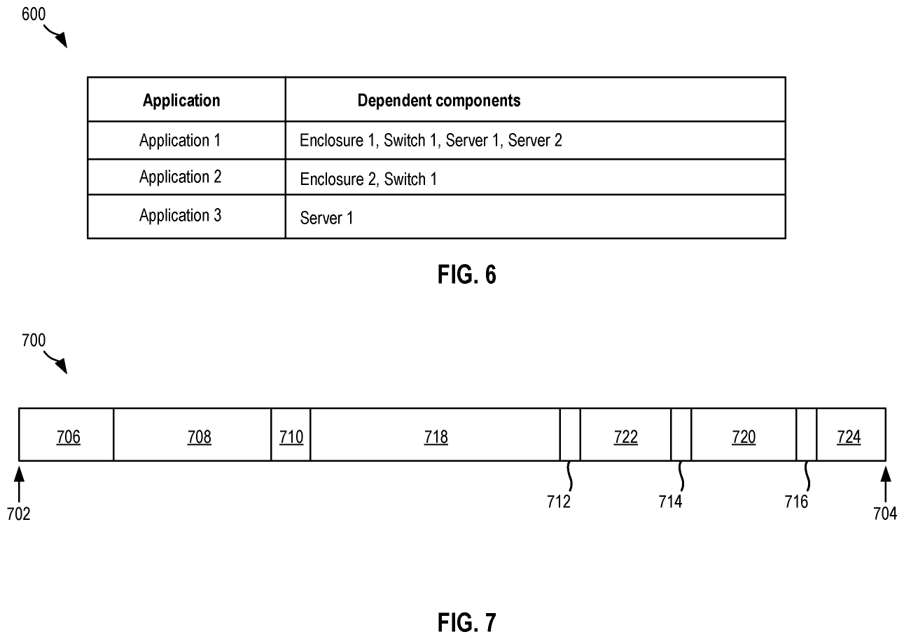

FIG. 6 depicts a dictionary 600, in accordance with one embodiment. As an option, the present dictionary 600 may be implemented in conjunction with features from any other embodiment listed herein, such as those described with reference to the other FIGS. Of course, however, such dictionary 600 and others presented herein may be used in various applications and/or in permutations which may or may not be specifically described in the illustrative embodiments listed herein. Further, the dictionary 600 presented herein may be used in any desired environment.

The dictionary 600 may be generated using techniques described elsewhere above, e.g., see method 200. The dictionary includes entries for a plurality of applications, e.g., see Application 1, Application 2 and Application 3. The dictionary includes dependent component definitions each associated with a different one of the dictionary entries, e.g., see Enclosure 1, Switch 1, Server 1, Server 2 and Enclosure 2.

FIG. 7 depicts a schedule 700, in accordance with one embodiment. As an option, the present schedule 700 may be implemented in conjunction with features from any other embodiment listed herein, such as those described with reference to the other FIGS. Of course, however, such schedule 700 and others presented herein may be used in various applications and/or in permutations which may or may not be specifically described in the illustrative embodiments listed herein. Further, the schedule 700 presented herein may be used in any desired environment.

The schedule may be generated and used for performing a plurality of maintenance activities. The schedule may be based on a position of the footprint coverage region with respect to the one or more activation regions. In some approaches, the schedule is based on a finite period of time, e.g., see beginning time 702 (9 AM) and ending time 704 (6 PM). During a first portion 706 of the schedule, information of the schedule may detail components that are inactive, e.g., component A, component B and component C, and applications that are inactive, e.g., application P, application Q and application R. In a second portion 708 of the schedule, information of the schedule may detail that all applications are inactive to perform a storage system upgrade. In the portions 710, 712, 714 and 716 of the schedule, nothing may be scheduled to be performed, e.g., no maintenance activities and no requests are fulfilled. In the portions 718 and 720 of the schedule, application servicing is scheduled. In another portion 722 of the schedule, information of the schedule may detail components that are inactive, e.g., component C and component D, applications that are inactive, e.g., application P, and devices that are inactive, e.g., device W and device X. Similarly, in portion 724 of the schedule, information of the schedule may detail applications that are inactive, e.g., application R, and devices that are inactive, e.g., device W and device X.

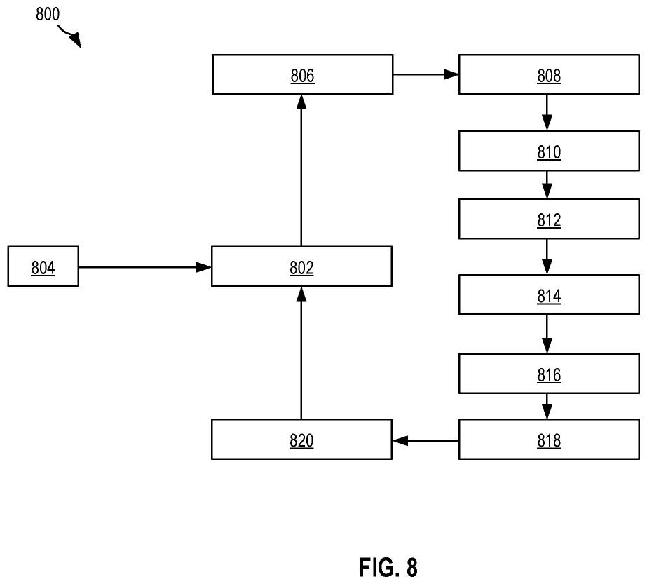

Now referring to FIG. 8, a flowchart of a method 800 is shown according to one embodiment. The method 800 may be performed in accordance with the present invention in any of the environments depicted in FIGS. 1-10, among others, in various embodiments. Of course, more or fewer operations than those specifically described in FIG. 8 may be included in method 800, as would be understood by one of skill in the art upon reading the present descriptions.

Each of the steps of the method 800 may be performed by any suitable component of the operating environment. For example, in various embodiments, the method 800 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 800. Illustrative processors include, but are not limited to, a central processing unit (CPU), an application specific integrated circuit (ASIC), a field programmable gate array (FPGA), etc., combinations thereof, or any other suitable computing device known in the art.

It may be prefaced that method 800 includes operations for polling to determine maintenance activities that are to be performed by a first satellite. For example, a plurality of devices may be polled, e.g., see operation 802, in order to obtain device information, e.g., see operation 804. A resource parser may be used to parse the received device information, e.g., see operation 806. This parsing may be performed to identify information for a dictionary and/or schedule and/or service requests, in some approaches. Components associated with the maintenance activities may be identified, e.g., see operation 808, and priority mapping may be performed, e.g., see operation 810. In some approaches, masking ability may be located based on the information obtained by the polling, e.g., see operation 812, and a target for estimation may be enquired, e.g., see operation 814. A slot may be located using the information, and additional polling may be performed for slot realization, e.g., see operations 816 and 818. Finally, a trigger event may be performed based on the analysis performed in any of the other operations, e.g., see operation 820.

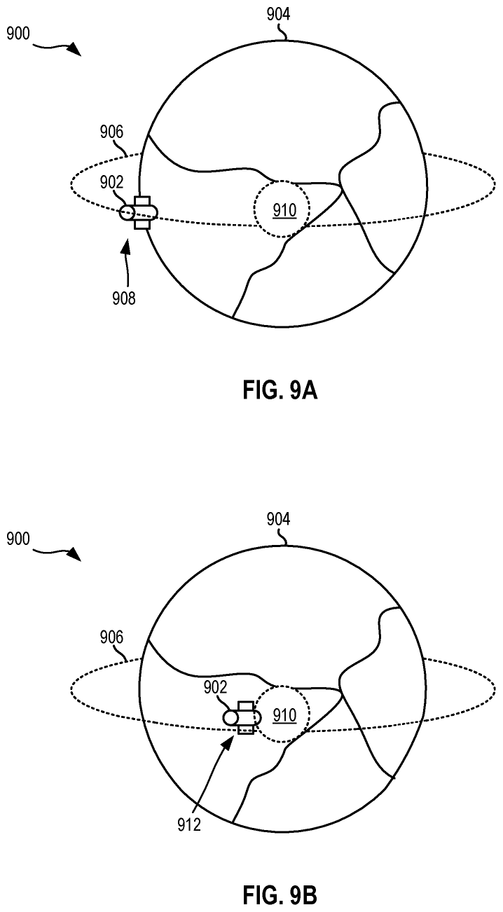

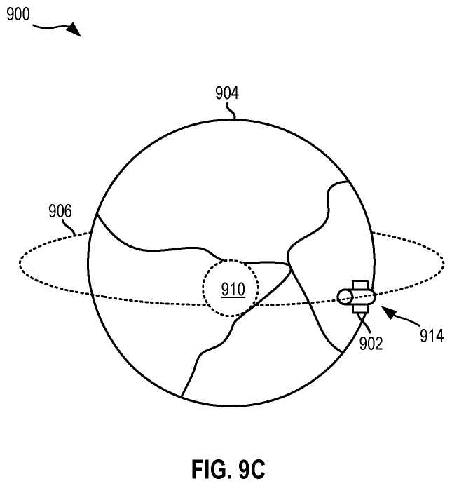

FIGS. 9A-9C depicts an environment 900, in accordance with several embodiments. As an option, the present environment 900 may be implemented in conjunction with features from any other embodiment listed herein, such as those described with reference to the other FIGS. Of course, however, such environment 900 and others presented herein may be used in various applications and/or in permutations which may or may not be specifically described in the illustrative embodiments listed herein. Further, the environment 900 presented herein may be used in any desired environment.

Referring first to FIG. 9A, the environment includes a first LEO satellite 902 that is orbiting Earth 904 along a first orbital path 906. Furthermore, the first LEO satellite 902 is located at a first position 908, and is approaching a first activation region of Earth's surface, where a first application is expected to be and/or recorded as previously being activated on the first satellite for a duration that a footprint coverage region of the first satellite is within the first activation region 910.

Referring now to FIG. 9B, the first LEO satellite 902 is located at a second position 912. At the second position, a determination may be made that the footprint coverage region of the first satellite is within the first activation region 910. In response to the determination that the footprint coverage region of the first satellite is within the first activation region, first application updates are prevented from being performed on the first LEO satellite.

Referring now to FIG. 9C, the first LEO satellite 902 is located at a third position 914. At the third position, a determination may be made that the footprint coverage region of the first satellite is not within the first activation region. In response to the determination that the footprint coverage region of the first satellite is not within the first activation region, performance of the first application updates is caused on the first LEO satellite.

Software for performing the methodology of FIG. 2 may be deployed to a computer that will perform the method via any known technique. An exemplary process for such deployment is presented immediately below.

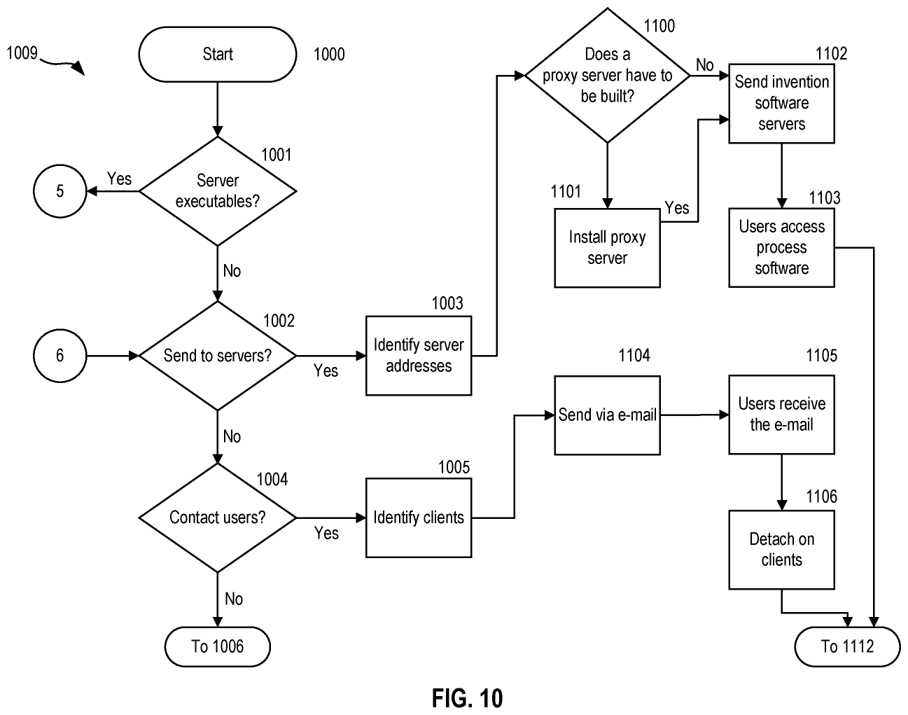

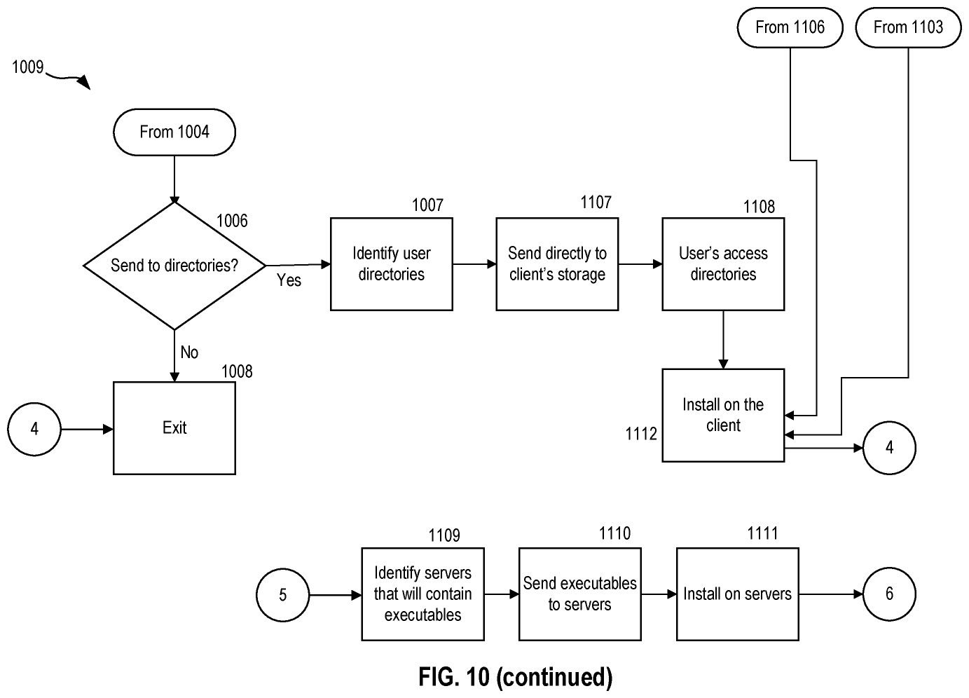

Now referring to FIG. 10, a flowchart of a method 1009 is shown according to one embodiment. The method 1009 may be performed in accordance with the present invention in any of the environments depicted in FIGS. 1-10, among others, in various embodiments. Of course, more or fewer operations than those specifically described in FIG. 10 may be included in method 1009, as would be understood by one of skill in the art upon reading the present descriptions.

Each of the steps of the method 1009 may be performed by any suitable component of the operating environment. For example, in various embodiments, the method 1009 may be partially or entirely performed by a computer, or some other device having one or more processors therein. The processor, e.g., processing circuit(s), chip(s), and/or module(s) implemented in hardware and/or software, and preferably having at least one hardware component, may be utilized in any device to perform one or more steps of the method 1009. Illustrative processors include, but are not limited to, a central processing unit (CPU), an application specific integrated circuit (ASIC), a field programmable gate array (FPGA), etc., combinations thereof, or any other suitable computing device known in the art.

While it is understood that the process software for selective performance of application updates based on a satellite's footprint coverage region's position with respect to activation regions may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Step 1000 begins the deployment of the process software. An initial step is to determine if there are any programs that will reside on a server or servers when the process software is executed (1001). If this is the case, then the servers that will contain the executables are identified (1109). The process software for the server or servers is transferred directly to the servers' storage via FTP or some other protocol or by copying though the use of a shared file system (1110). The process software is then installed on the servers (1111).

Next, a determination is made on whether the process software is to be deployed by having users access the process software on a server or servers (1002). If the users are to access the process software on servers, then the server addresses that will store the process software are identified (1003).

A determination is made if a proxy server is to be built (1100) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (1101). The process software is sent to the (one or more) servers either via a protocol such as FTP, or it is copied directly from the source files to the server files via file sharing (1102). Another embodiment involves sending a transaction to the (one or more) servers that contained the process software, and have the server process the transaction and then receive and copy the process software to the server's file system. Once the process software is stored at the servers, the users via their client computers then access the process software on the servers and copy to their client computers file systems (1103). Another embodiment is to have the servers automatically copy the process software to each client and then run the installation program for the process software at each client computer. The user executes the program that installs the process software on his client computer (1112) and then exits the process (1008).

In step 1004 a determination is made whether the process software is to be deployed by sending the process software to users via e-mail. The set of users where the process software will be deployed are identified together with the addresses of the user client computers (1005). The process software is sent via e-mail (1104) to each of the users' client computers. The users then receive the e-mail (1105) and then detach the process software from the e-mail to a directory on their client computers (1106). The user executes the program that installs the process software on his client computer (1112) and then exits the process (1008).

Lastly, a determination is made on whether the process software will be sent directly to user directories on their client computers (1006). If so, the user directories are identified (1007). The process software is transferred directly to the user's client computer directory (1107). This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the process software (1108). The user executes the program that installs the process software on his client computer (1112) and then exits the process (1008).

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
generating a map of a first satellite's orbital path with respect to Earth's surface;
identifying, on the map along the first satellite's orbital path, a first activation region of Earth's surface, wherein a first application is expected to be activated on the first satellite for a duration that a footprint coverage region of the first satellite is within the first activation region;
in response to a determination that the footprint coverage region of the first satellite is within the first activation region, preventing first application updates from being performed on the first satellite; and
in response to a determination that the footprint coverage region of the first satellite is not within the first activation region, causing performance of the first application updates on the first satellite.

2. The computer-implemented method of claim 1, comprising: generating a dictionary, wherein the dictionary includes entries for a plurality of applications including the first application, wherein the dictionary includes dependent component definitions each associated with a different one of the dictionary entries.

3. The computer-implemented method of claim 2, comprising:
receiving an update for a second application, wherein the update for the second application is received while the footprint coverage region of the first satellite is within the first activation region;
in response to receiving the update for the second application, comparing the dependent component definition associated with the second application to the dependent component definition associated with the first application to determine whether performance of the update for the second application while the footprint coverage region of the first satellite is within the first activation region is capable of deactivating the first application on the first satellite;
in response to a determination, based on results of the comparison, that at least one component of the dependent component definition associated with the second application matches at least one component of the dependent component definition associated with the first application, preventing the second application update from being performed on the first satellite; and
in response to a determination, based on the results of the comparison, that none of the components of the dependent component definition associated with the second application match any of the components of the dependent component definition associated with the first application, causing performance of the second application updates on the first satellite.

4. The computer-implemented method of claim 1, wherein the first satellite is a low Earth orbit (LEO) satellite.

5. The computer-implemented method of claim 1, wherein preventing the first application updates from being performed on the first satellite includes delaying the first application updates from being performed on the first satellite until a determination is made that the footprint coverage region of the first satellite is not within the first activation region.

6. The computer-implemented method of claim 1, comprising: generating a table of events queued to be performed by the first satellite; and determining a priority of the events of the table based on at least one predetermined metric.

7. The computer-implemented method of claim 6, wherein the at least one predetermined metric is selected from the group consisting of: a timeline of when the event can be performed, how long an event is anticipated to take to be performed, and a maximum amount of time that the event can be delayed.

8. The computer-implemented method of claim 6, comprising: in response to the determination that the footprint coverage region of the first satellite is within the first activation region, using the determined priorities to determine whether to cause performance of a first of the events during a duration that a footprint coverage region of the first satellite is within the first activation region.

9. The computer-implemented method of claim 1, comprising:
identifying, on the map along the first satellite's orbital path, a plurality of other activation regions of Earth's surface; and
generating a schedule for performing a plurality of maintenance activities, wherein the plurality of maintenance activities include the first application updates, wherein the schedule is based on a position of the footprint coverage region with respect to the first activation region and the other activation regions.

10. A computer program product, the computer program product comprising a computer readable storage medium having program instructions embodied therewith, the program instructions readable and/or executable by a computer to cause the computer to:
generate a map of a first satellite's orbital path with respect to Earth's surface;
identify, on the map along the first satellite's orbital path, a first activation region of Earth's surface, wherein a first application is expected to be activated on the first satellite for a duration that a footprint coverage region of the first satellite is within the first activation region;
in response to a determination that the footprint coverage region of the first satellite is within the first activation region, prevent first application updates from being performed on the first satellite; and
in response to a determination that the footprint coverage region of the first satellite is not within the first activation region, cause performance of the first application updates on the first satellite.

11. The computer program product of claim 10, the program instructions readable and/or executable by the computer to cause the computer to: generate a dictionary, wherein the dictionary includes entries for a plurality of applications including the first application, wherein the dictionary includes dependent component definitions each associated with a different one of the dictionary entries.

12. The computer program product of claim 11, the program instructions readable and/or executable by the computer to cause the computer to:
receive an update for a second application, wherein the update for the second application is received while the footprint coverage region of the first satellite is within the first activation region;
in response to receiving the update for the second application, compare the dependent component definition associated with the second application to the dependent component definition associated with the first application to determine whether performance of the update for the second application while the footprint coverage region of the first satellite is within the first activation region is capable of deactivating the first application on the first satellite;
in response to a determination, based on results of the comparison, that at least one component of the dependent component definition associated with the second application matches at least one component of the dependent component definition associated with the first application, prevent the second application update from being performed on the first satellite; and
in response to a determination, based on the results of the comparison, that none of the components of the dependent component definition associated with the second application match any of the components of the dependent component definition associated with the first application, cause performance of the second application updates on the first satellite.

13. The computer program product of claim 10, wherein the first satellite is a low Earth orbit (LEO) satellite.

14. The computer program product of claim 10, wherein preventing the first application updates from being performed on the first satellite includes delaying the first application updates from being performed on the first satellite until a determination is made that the footprint coverage region of the first satellite is not within the first activation region.

15. The computer program product of claim 10, the program instructions readable and/or executable by the computer to cause the computer to: generate a table of events queued to be performed by the first satellite; and determine a priority of the events of the table based on at least one predetermined metric.

16. The computer program product of claim 15, wherein the at least one predetermined metric is selected from the group consisting of: a timeline of when the event can be performed, how long an event is anticipated to take to be performed, and a maximum amount of time that the event can be delayed.

17. The computer program product of claim 15, the program instructions readable and/or executable by the computer to cause the computer to: in response to the determination that the footprint coverage region of the first satellite is within the first activation region, use the determined priorities to determine whether to cause performance of a first of the events during a duration that a footprint coverage region of the first satellite is within the first activation region.

18. The computer program product of claim 10, the program instructions readable and/or executable by the computer to cause the computer to:
identify, on the map along the first satellite's orbital path, a plurality of other activation regions of Earth's surface; and
generate a schedule for performing a plurality of maintenance activities, wherein the plurality of maintenance activities include the first application updates, wherein the schedule is based on a position of the footprint coverage region with respect to the first activation region and the other activation regions.

19. A system, comprising:
a processor; and
logic integrated with the processor, executable by the processor, or integrated with and executable by the processor, the logic being configured to:
generate a map of a first satellite's orbital path with respect to Earth's surface;
identify, on the map along the first satellite's orbital path, a first activation region of Earth's surface, wherein a first application is expected to be activated on the first satellite for a duration that a footprint coverage region of the first satellite is within the first activation region;
in response to a determination that the footprint coverage region of the first satellite is within the first activation region, prevent first application updates from being performed on the first satellite; and
in response to a determination that the footprint coverage region of the first satellite is not within the first activation region, cause performance of the first application updates on the first satellite.

20. The system of claim 19, the logic being configured to: generate a dictionary, wherein the dictionary includes entries for a plurality of applications including the first application, wherein the dictionary includes dependent component definitions each associated with a different one of the dictionary entries.
